(19) United States
(12) Patent Application Publication
(10) Pub. No.: US 2026/0029922 A1
(43) Pub. Date: Jan. 29, 2026

(54) MEMORY CONTROLLER FOR USE WITH ROW-BUFFER MEMORY

(71) Applicant: Advanced Micro Devices, Inc., Santa Clara, CA (US)

(72) Inventor: James R. Magro, Lakeway, TX (US)

(73) Assignee: Advanced Micro Devices, Inc., Santa Clara, CA (US)

(21) Appl. No.: 19/096,140

(22) Filed: Mar. 31, 2025

Related U.S. Application Data
(60) Provisional application No. 63/674,886, filed on Jul. 24, 2024.

(51) Int. Cl. G06F 3/06

(52) U.S. Cl. CPC G06F 3/0613; G06F 3/0659; G06F 3/0673

(57) ABSTRACT

A memory controller includes a command queue and an arbiter. The command queue is operable to store a plurality of memory access requests for accessing a row-buffer memory. The arbiter is coupled to the command queue and is operable to pick memory access requests from the command queue for issuance to the row-buffer memory according to a preference for memory access requests that access a data element in a sense amplifier or in a first row buffer of the row-buffer memory.

### BACKGROUND

Computer systems typically use inexpensive and high density dynamic random access memory (DRAM) chips for main memory. Most DRAM chips sold today are compatible with various double data rate (DDR) DRAM standards promulgated by the Joint Electron Devices Engineering Council (JEDEC). DDR DRAMs provide asymmetric access times because memory access requests to “open” rows (also known as pages) of the memory can be completed faster than memory access requests to “closed” rows. The reason is that when a row is opened, the contents of the memory cells in the row are sensed and stored in a “page buffer”, which is a set of latching sense amplifiers that can be read from and written to. The memory cells in the open row can then be accessed in the page buffer very quickly without having to access the memory array. When the page buffer is closed, its contents are re-written to the memory array, and another page can be opened. A typical DDR memory controller maintains a queue to store pending read and write requests to allow the memory controller to pick the pending requests out of order and thereby to increase memory bus efficiency. For example, the memory controller can retrieve multiple memory access requests to the same row in a given bank and rank of memory (referred to as “page hits”) from the queue out of order and issue them consecutively to the memory system to avoid the overhead of precharging the current row and activating another row repeatedly.

### BRIEF DESCRIPTION OF THE DRAWINGS

FIG. 1 illustrates in block diagram form a data processing system according to some implementations;

FIG. 2 illustrates a first timing diagram useful in understanding the operation of the row-buffer memory based data processing system of FIG. 1;

FIG. 3 illustrates a second timing diagram useful in understanding the operation of the data processing system of FIG. 1:

FIG. 4 illustrates a third timing diagram useful in understanding the operation of the row-buffer memory based data processing system of FIG. 1;

FIG. 5 illustrates a block diagram of a memory controller that can be used as the memory controller of FIG. 1 according to some implementations;

FIG. 6 illustrates a block diagram of a portion of the memory controller of FIG. 5 according to some implementations;

FIG. 7 illustrates a page table that can be used as the row-buffer aware page table of the memory controller of FIG. 6 according to some implementations; and

FIG. 8 illustrates a flow chart of a method of accessing a row-buffer memory by a memory controller according to some implementations.

In the following description, the use of the same reference numerals in different drawings indicates similar or identical items. Unless otherwise noted, the word “coupled” and its associated verb forms include both direct connection and indirect electrical connection by means known in the art, and unless otherwise noted any description of direct connection implies alternate implementations using suitable forms of indirect electrical connection as well. The following Detailed Description is directed to electronic circuitry, and the description of a block shown in a drawing figure implies the implementation of the described function using suitable electronic circuitry, unless otherwise noted.

### DETAILED DESCRIPTION OF ILLUSTRATIVE IMPLEMENTATIONS

To improve the effective number of page hits, a new type of DDR memory has been developed that includes “row buffers”. Instead of simply including a single latching sense amplifier to store the contents of the activated row that can be accesses at high speed, a row-buffer memory includes one or more row buffers that can be used to store contents of other rows of the memory that can be accessed at high speed like the latching sense amplifiers. For example, in one implementation, the contents of an activated row can be moved into a row buffer when the row is precharged. In another exemplary implementation, a row buffer is allocated when particular row is first activated so that its contents remain accessible even after the row is precharged. An improved memory controller, data processing system, and method as described herein efficiently leverage the availability of the row-buffer memory according to a preference for memory access requests that access a data element in a sense amplifier or in a row buffer of the row-buffer memory.

Contemporary DRAM memory controllers improve the efficiency of usage of the memory bus by mixing accesses to open pages with accesses to closed pages, partially hiding the overhead of opening and closing pages. Instead of merely closing a page, moving the contents of the accessed row into a “row buffer” in which the contents can still be read at high speed, while the latching sense amplifiers can be used for another purpose, such as refresh cycles and ACT and read cycles to another row in the same bank, provide further efficiency gains. In some implementations, data can be written to the row buffer at high speed as well before the page is fully closed and the potentially modified contents of the row buffer are re-written into the memory array. A memory controller for accessing a row-buffer memory improves bus efficiency by issuing accesses with a preference for memory accesses that are to either a sense amplifier or a row buffer of the row-buffer memory.

A memory controller includes a command queue and an arbiter. The command queue is operable to store a plurality of memory access requests for accessing a row-buffer memory. The arbiter is coupled to the command queue and is operable to pick memory access requests from the command queue according to a preference for memory access requests that access a data element in a sense amplifier or in a first row buffer of the row-buffer memory.

A data processing system includes a data processor including a memory controller and a row-buffer memory coupled to the memory controller. The memory controller includes a command queue operable to store a plurality of memory access requests for accessing the row-buffer memory, and an arbiter coupled to the command queue and operable to pick memory access requests from the command queue for issuance to the row-buffer memory according to a preference for memory access requests that access a data element in a sense amplifier or in a first row buffer of the row-buffer memory.

A method of accessing a row-buffer memory by a memory controller includes storing a plurality of memory access requests for accessing the row-buffer memory in a command queue. Memory access requests are picked from the command queue according to a preference for memory access requests that access a data element in either a sense amplifier or a first row buffer of the row-buffer memory. Picked memory access requests to the row-buffer memory.

By scheduling memory accesses to a row-buffer memory with a preference for either memory access requests to open rows or memory access requests to rows stored in one or more row buffers, a memory controller, data processing system, and method as described herein leverages the row-buffer memory to increase memory bus efficiency and bandwidth. For example, it allows refresh commands to a bank to occur while the contents of the row buffer are still available for read accesses (in one implementation) or read and write accesses (in another implementation). It does so simply with only minor modifications to existing memory controller circuitry.

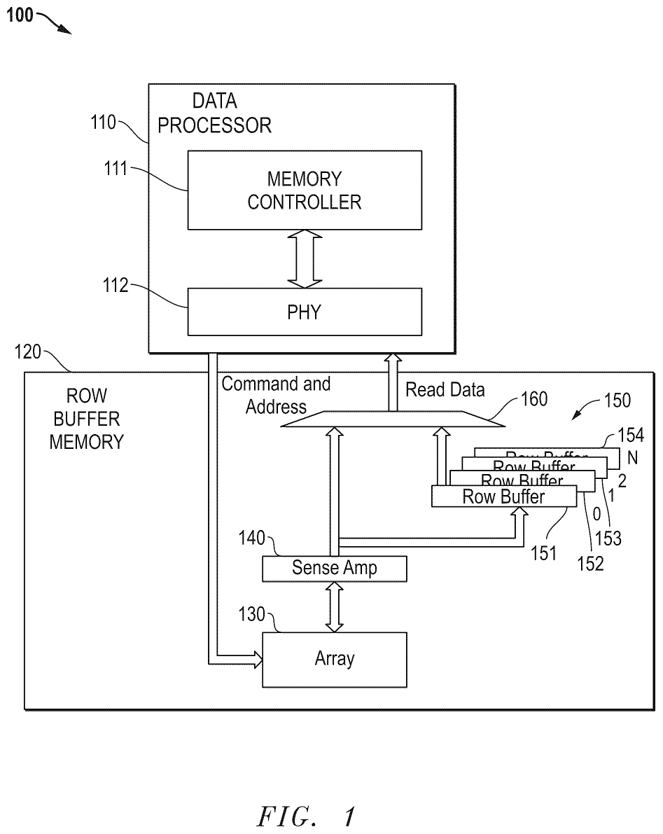

FIG. 1 illustrates in block diagram form a data processing system 100 according to some implementations. Data processing system 100 includes generally a data processor 110 and a row-buffer memory 120. Data processor 110 includes a memory controller 111 and a physical interface circuit 112 bidirectionally connected to memory controller 111.

Row-buffer memory 120 is a double data rate dynamic random access memory (DDR DRAM) having an input for receiving command and address signals from data processor 110, and a bidirectional data bus connected to data processor 110. FIG. 1 shows only the example of a read access in which it provides read data to the host processor, but in actual implementations, the data bus is bidirectional.

Row-buffer memory 120 includes a memory array 130, a sense amplifier 140, a set of row buffers 150, and a multiplexer 160. Memory array 130 is organized into banks, allowing concurrency and overlapping of accesses between accesses to different banks. In DDR DRAMs, when a bank is first accessed, the contents of the accessed row are read into a sense amplifier such as sense amplifier 140. Sense amplifier 140 is a representative sense amplifier for a particular bank, and there is a corresponding sense amplifier, not shown in FIG. 1, for each bank of row-buffer memory 120. Sense amplifier 140 is formed with a set of latching sense amplifiers that are circuits that detect and amplify the small electrical charges stored in corresponding memory cells that represent binary logic states, and are static and retain their contents, and can thereafter be accessed at relatively high speed without accessing memory array 130 again.

When a row is opened, memory controller 111 sends an activate (ACT) command to row-buffer memory 120 specifying the accessed bank, such as by sending a bank number and a row number within the bank. The ACT command causes sense amplifier 140 to sense the contents of the accessed row. After memory controller 111 activates the bank, it completes the memory access request by performing a read or write command, as the case may be, and row-buffer memory 120 completes the access at high speed by accessing sense amplifier 140 but not memory array 130. A multiplexer 160 selects the source of the data, e.g., the open row stored in sense amplifier 140 or in one of row buffers 150.

In response to a subsequent precharge command, or a read or write access with the auto-precharge attribute set, the contents of the latching sense amplifier—possibly modified by a write command—are rewritten to the memory array and also to a row buffer. In the example shown in FIG. 1, memory 120 has multiple row buffers per bank, allowing the contents of all the row buffers to be accessed at high speed like the contents of sense amplifier 140. Row Buffer 0 stores the current contents of the most recently precharged row, and it will be accessible for future cycles. If a future memory cycle accesses a new row not stored in sense amplifier 140 or a row buffer, then the contents of the different row are sensed by sense amplifier 140 and optionally stored in an available row buffer.

In some implementations, the contents of a row buffer can be read from but not written to. In this case, memory controller 111 selects memory access requests from among its received memory access requests with a preference for reads to an open row in the sense amplifier, writes to the open row in the sense amplifier, and reads to one or more row buffers. If memory controller 111 selects a read or write access to a new row that is neither a read or write access to the open row or a read access to a recently open row, then memory controller 111 first precharges the currently active row by sending an express precharge command or a read or write access to the currently active row with the auto-precharge attribute set. In response to the precharge operation, row-buffer memory 120 first writes the contents of sense amplifier 140 back to the corresponding row in memory array 130, and in some embodiments, moves the contents of sense amplifier 140 into a row buffer (if there is only one row buffer) or one of row buffers 150 specified by memory controller 111. Moving the contents of sense amplifier 140 into row buffers 150 involves either overwriting the prior contents of row buffer 151 if row-buffer memory 120 implements only a single row buffer per bank, or storing the contents of sense amplifier 140 into a selected row buffer specified by memory controller 111 if there are multiple row buffers. If the contents of sense amplifier 140 have been written to a row buffer, then the new row can be activated by sensing the contents of the new row in sense amplifiers 140. Memory controller 111 then completes the requested read or write operation completes using a column address strobe (CAS) command.

In other implementations, the contents of a recently open row stored in the row buffer can be both read from and written to. In this case, memory controller 111 and row-buffer memory 120 operate as before, except that row-buffer memory 120 must perform a write of its contents from the last row buffer in row buffers 150 to the memory array. This implementation provides more flexibility and performance, but requires additional circuit complexity of the memory for writing new data into the row buffer, and writing data from the last row buffer back into memory array 130 before the row buffer is used to store the contents of another row. In addition, the memory controller would also require additional circuit complexity. It would have to keep track of all the currently open rows in either the latching sense amplifier or a row buffer, and make arbitration decisions to favor memory access requests to either to a row stored in the latching sense amplifier or a row stored in the row buffer. Thus, there is an engineering design tradeoff between simple read-only row buffers, and more complex read-write row buffers. Because of the additional circuit complexity to support both reads and writes in the row buffer, some implementations will prefer to implement one or more row buffers that can be read from but not written to. In these implementations, the memory controller's arbiter would implement a preference for read requests but not write requests to a memory location whose data is stored in a row buffer of the row-buffer memory.

The architecture of data processing system 100 is improved compared to known architectures because it reduces the asymmetry of accesses. Because computer software tends to repetitively access regions of memory that have been recently accessed, a characteristic known as “locality of access”, and because contemporary data processors are commonly multi-core and multi-threaded, row-buffer memory 120 provides efficiency improvements over existing DRAMs by allowing high-speed accesses to more than one row per bank. These efficiency improvements will now be described with respect to specific examples.

FIG. 2 illustrates a first timing diagram 200 useful in understanding the operation of data processing system 100 of FIG. 1. In first timing diagram 200, the horizontal dimension represents time with various signals of interest illustrated in the vertical dimension, but with the axes not specifically shown. Shown in first timing diagram 200 are four signal groups of interest, including a command and address signal group labelled “CMD”, a data bus signal group labelled “DQ”, a sense amplifier data signal group labelled “DATA (SA)”, and a row buffer data signal group labelled “DATA (RB)”.

The first command is an activate (ACT) command that accesses a particular row in a particular bank. Data labelled “Buf0” from the associated row is read from the memory array into the sense amplifier.

Subsequently, row-buffer memory 120 receives a read command “RdCAS” with an auto-precharge (AP) attribute after a minimum delay time of “t_{RCD}” following the ACT command. After a CAS latency delay time of “t_{CL}”, row-buffer memory 120 provides the requested data to the host processor from the sense amplifier on the DQ signals. As shown in first timing diagram 200, the auto-precharge attribute causes the data from the sense amplifier to be written into the data buffer, such that a first data buffer stores the Buf0 data. The auto-precharge attribute also causes the BUF0 data to be re-written into the memory array, thereby refreshing the contents of the memory cells along the accessed row in the accessed bank with any modifications of the Buf0 data due to intervening write cycles. In an alternate implementation, memory controller 111 can provide an ACT command that specifies a row buffer to allocate the data to, rather than the precharge command.

As shown in first timing diagram 200, the data from a selected column in the row is output a column address strobe (CAS) delay time t_{CL} afterward. Since the page has been “closed”, the Buf0 data is no longer in an “open row”, but is now stored in a row buffer, and data requested by subsequent read commands to that row are output from the row buffer. The data from this row is available for read accesses until it is removed from the row buffer.

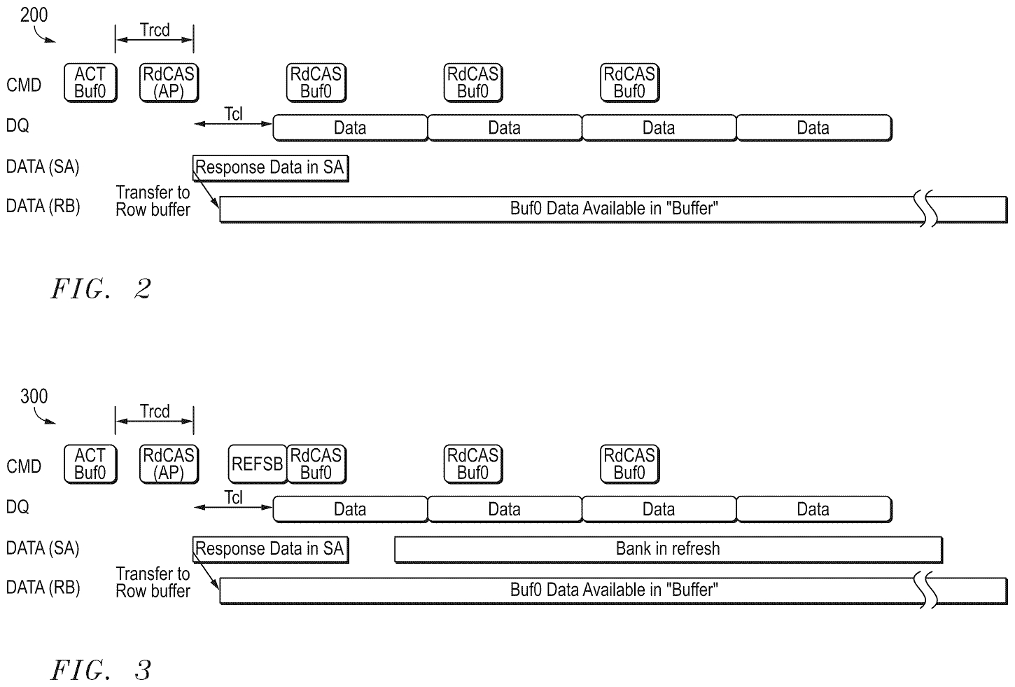

FIG. 3 illustrates a second timing diagram 300 useful in understanding the operation of data processing system 100 of FIG. 1. In second timing diagram 300, the horizontal dimension represents time with various signals of interest illustrated in the vertical dimension, but with the axes not specifically shown. Second timing diagram 300 shows an ACT command and a RdCAS command as in first timing diagram 200, but additionally shows the host processor issuing a same-bank refresh command labelled “REFSB” between the first and second RdCAS commands, in which the REFSB command refreshes the bank with the Buf0 data.

The REFSB requires many cycles to complete, in which each row in the selected memory bank is read into the sense amplifier and then re-written to the memory array to restore the charge of the memory cell capacitors to full strength. As shown in second timing diagram 300, the REFSB operation overlaps the row buffer read operations and improves the efficiency of the memory system by allowing these reads to occur while the bank is being refreshed. Because of the locality of reference property, a row-buffer aware memory controller has the opportunity to schedule these further read accesses to the Buf0 data stored in row buffer 151 while the same-bank refresh is taking place using sense amplifier 140 and sense amplifiers in other corresponding banks. Depending on the composition of the accesses, memory controller 111 can almost completely hide the overhead of the REFSB to this row under reads to the row.

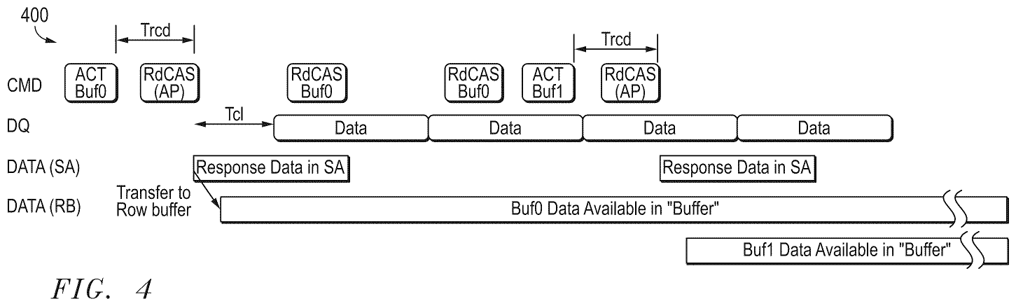

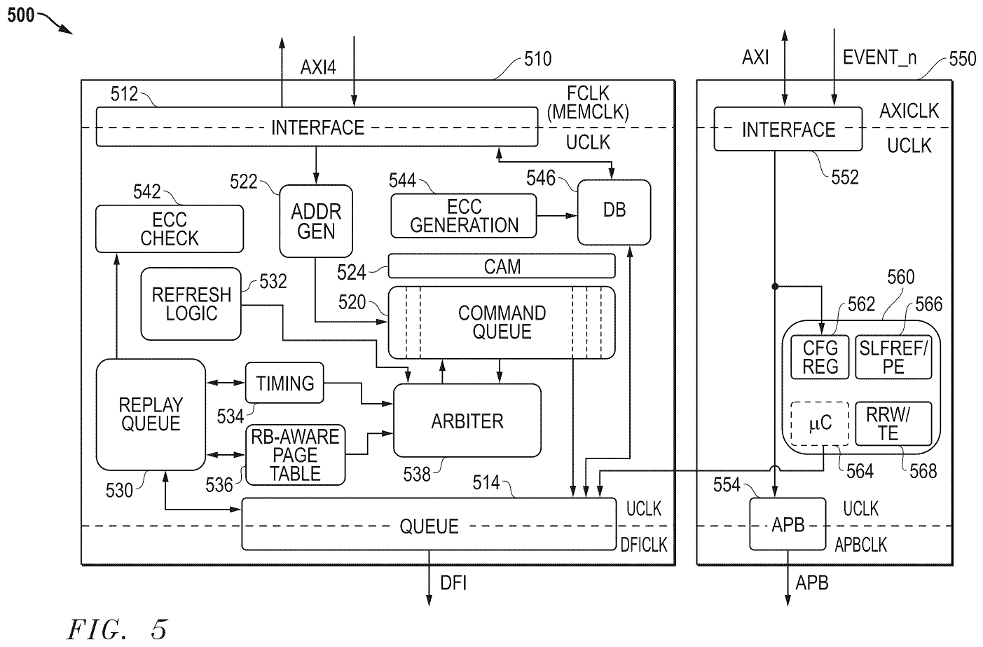

FIG. 4 illustrates a third timing diagram 400 useful in understanding the operation of data processing system 100 of FIG. 1. In third timing diagram 400, the horizontal dimension represents time with various signals of interest illustrated in the vertical dimension, but with the axes not specifically shown. Third timing diagram 400 again shows an ACT command to a row with the Buf0 data, followed by three RdCAS commands to read the Buf0 data. The first RdCAS command includes the auto-precharge attribute and accesses data from the sense amplifier. The additional two RdCAS commands read data from the read buffer. After the second additional RdCAS command, the memory controller sends a second ACT command for a different row with the data labelled “Buf1” stored in row buffer 151. In this case, the second ACT command causes the Buf1 data to be transferred from the memory array to Buf1, thereby hiding the overhead of activating the second row. Thereafter, the data from the row indicated by the second ACT command is accessible in Buf1 or another buffer as specified by the memory controller.

Since only read operations were allowed after the first command with further read accesses to the row buffer allowed, the overwriting of the Buf0 data by the Buf1 data does not result in loss of data or prevent fast accessing of data from the row buffer.

As shown in third timing diagram 400, after the second ACT command, a RDCAS command with the auto-precharge attribute set causes the Buf1 data to be written into a buffer. When row-buffer memory 120 only has one row buffer per bank, the fourth RDCAS command causes the Buf1 data to overwrite the Buf0 data in the sole row buffer such that the Buf1 data, but not the Buf0 data, is accessible in the sole buffer for reads. When row-buffer memory 120 only multiple buffers per bank, the fourth RDCAS command causes the Buf0 data to be shifted into an older buffer, and the Buf1 data to be written into the first data buffer, and both the Buf0 data and the Buf1 data to be accessible from the row buffer.

Other implementations allow writes to the row buffer in which the write commands overwrite some or all of the contents of the row buffer. In these cases, the memory controller could provide a command to the memory to cause the contents of the row buffer to be written to the memory array before it is overwritten in the row buffer. Because it adds complexity to the memory and the memory controller, the simpler implementation described above may be preferable.

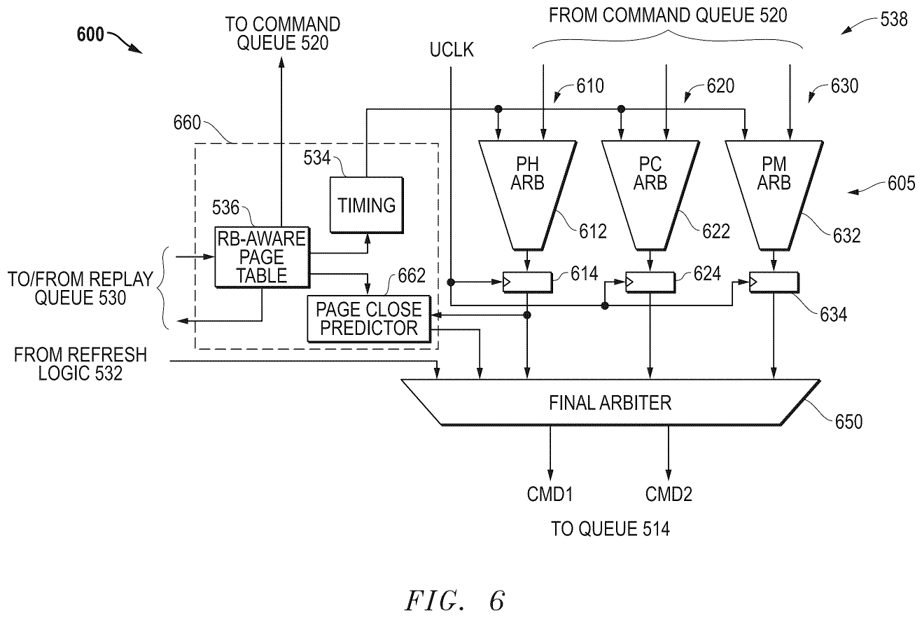

FIG. 5 illustrates a block diagram of a memory controller 500 that can be used as the memory controller of FIG. 1 according to some implementations. Memory controller 500 includes generally a memory channel controller 510 and a power controller 550 that in an exemplary implementation are implemented in hardware circuitry. Memory channel controller 510 includes an interface 512, a queue 514, a command queue 520, an address generator 522, a content addressable memory 524 labelled “CAM”, a replay queue 530, a refresh logic 532, a timing block 534, a row-buffer aware page table 536, an arbiter 538, an error correction code (ECC) check block 542, an ECC generation block 544, and a data buffer 546.

Interface 512 has a first bidirectional connection to data fabric 250 over an external bus, and has an output. In memory controller 500, this external bus is compatible with the advanced extensible interface version four specified by ARM Holdings, PLC of Cambridge, England, known as “AXI4”, but can be other types of interfaces in other implementations. Interface 512 translates memory access requests from a first clock domain known as the FCLK (or MEMCLK) domain to a second clock domain internal to memory controller 500 known as the UCLK domain. Similarly, queue 514 provides memory accesses from the UCLK domain to the DFICLK domain associated with the DFI interface.

Address generator 522 decodes addresses of memory access requests received from data fabric 250 over the AXI4 bus. The memory access requests include access addresses in the physical address space represented as a normalized address. Address generator 522 converts the normalized addresses into a format that can be used to address the actual memory devices in the memory system, as well as to efficiently schedule related accesses. This format includes a region identifier that associates the memory access request with a particular rank, a row address, a column address, a bank address, and a bank group. On startup, the system BIOS queries the memory devices in the memory system to determine their size and configuration, and programs a set of configuration registers associated with address generator 522. Address generator 522 uses the configuration stored in the configuration registers to translate the normalized addresses into the appropriate format. Command queue 520 is a queue of memory access requests received from the memory accessing agents in the host data processor. Command queue 520 stores the address fields decoded by address generator 522 as well other address information that allows arbiter 538 to select memory accesses efficiently, including access type and quality of service (QoS) identifiers. Content addressable memory 524 includes information to enforce ordering rules, such as write after write (WAW) and read after write (RAW) ordering rules.

Replay queue 530 is a temporary queue for storing memory accesses picked by arbiter 538 that are awaiting responses, such as address and command parity responses, write cyclic redundancy check (CRC) responses for DDR4 DRAM or write and read CRC responses for GDDR5 DRAM. Replay queue 530 accesses ECC check block 542 to determine whether the returned ECC is correct or indicates an error. Replay queue 530 allows the accesses to be replayed in the case of a parity or CRC error of one of these cycles.

Refresh logic 532 includes state machines for various powerdown, refresh, and termination resistance (ZQ) calibration cycles that are generated separately from normal read and write memory access requests received from memory accessing agents. For example, if a memory rank is in precharge powerdown, it must be periodically awakened to run refresh cycles. Refresh logic 532 generates auto-refresh commands periodically to prevent data errors caused by leaking of charge off storage capacitors of memory cells in DRAM chips. In addition, refresh logic 532 periodically calibrates ZQ to prevent mismatch in on-die termination resistance due to thermal changes in the system. Refresh logic 532 also decides when to put DRAM devices in different power down modes.

Arbiter 538 is bidirectionally connected to command queue 520 and is the heart of memory channel controller 510. It improves efficiency by intelligent scheduling of accesses to improve the usage of the memory bus. Arbiter 538 uses timing block 534 to enforce proper timing relationships by determining whether certain accesses in command queue 520 are eligible for issuance based on DRAM timing parameters. For example, each DRAM has a minimum specified time between activate commands to the same bank, known as “t_{RC}”. Timing block 534 maintains a set of counters that determine eligibility based on this and other timing parameters specified in the JEDEC specification, and is bidirectionally connected to replay queue 530. Row-buffer aware page table 536 is bidirectionally connected to replay queue 530. It is row-buffer aware because it maintains state information about active pages and active row buffers in each bank and rank of the memory channel for arbiter 538. In the exemplary embodiment, this information allows command queue 520 to indicate whether the access is a page hit, in which a page hit accesses an open row or a recently open row that has a valid row buffer entry.

In response to write memory access requests received from interface 512, ECC generation block 544 computes an ECC according to the write data. Data buffer 546 stores the write data and ECC for received memory access requests. It outputs the combined write data/ECC to queue 514 when arbiter 538 picks the corresponding write access for dispatch to the memory channel.

Power controller 550 includes an interface 552 to an advanced extensible interface, version one (AXI), an APB interface 554, and a power engine 560. Interface 552 has a first bidirectional connection to the SMN, which includes an input for receiving an event signal labeled “EVENT_n” shown separately in FIG. 5, and an output. APB interface 554 has an input connected to the output of interface 552, and an output for connection to a PHY over an APB. Power engine 560 has an input connected to the output of interface 552, and an output connected to an input of queue 514. Power engine 560 includes a set of configuration registers 562, a microcontroller (μC) 564, a self-refresh controller 566 labelled “SLFREF/PE”, and a reliable read/write training engine 568 labelled “RRW/TE”. Configuration registers 562 are programmed over the AXI bus, and store configuration information to control the operation of various blocks in memory controller 500. Accordingly, configuration registers 562 have outputs connected to these blocks that are not shown in detail in FIG. 5. Self-refresh controller 566 is an engine that allows the manual generation of refreshes in addition to the automatic generation of refreshes by refresh logic 532. Reliable read/write training engine 568 provides a continuous memory access stream to memory or I/O devices for such purposes as DDR interface read latency training and loopback testing.

Memory channel controller 510 includes circuitry that allows it to pick memory accesses for dispatch to the associated memory channel. In order to make the desired arbitration decisions, address generator 522 decodes the address information into predecoded information including rank, row address, column address, bank address, and bank group in the memory system, and command queue 520 stores the predecoded information. Configuration registers 562 store configuration information to determine how address generator 522 decodes the received address information. Arbiter 538 uses the decoded address information, timing eligibility information indicated by timing block 534, and active page and row-buffer information indicated by row-buffer aware page table 536 to efficiently schedule memory accesses while observing other criteria such as QoS requirements. For example, arbiter 538 implements a preference for accesses to open pages and row buffers to avoid the overhead of precharge and activation commands required to change memory pages, and hides overhead accesses to one bank by interleaving them with read and write accesses to another bank. In particular during normal operation, arbiter 538 may decide to keep pages and row buffers open in different banks until they are required to be precharged prior to selecting a different page or to replacing a row buffer with the contents of another row.

FIG. 6 illustrates a block diagram of a portion 600 of memory controller 500 of FIG. 5 according to some implementations. Portion 600 includes arbiter 538 and a set of control circuits 660 associated with the operation of arbiter 538. Arbiter 538 includes a set of sub-arbiters 605 and a final arbiter 650. Sub-arbiters 605 include a sub-arbiter 610, a sub-arbiter 620, and a sub-arbiter 630. Sub-arbiter 610 includes a page hit arbiter 612 labeled “PH ARB”, and an output register 614. Page hit arbiter 612 has a first input connected to command queue 520, a second input, and an output. Register 614 has a data input connected to the output of page hit arbiter 612, a clock input for receiving the UCLK signal, and an output. Sub-arbiter 620 includes a page conflict arbiter 622 labeled “PC ARB”, and an output register 624. Page conflict arbiter 622 has a first input connected to command queue 520, a second input, and an output. Register 624 has a data input connected to the output of page conflict arbiter 622, a clock input for receiving the UCLK signal, and an output. Sub-arbiter 630 includes a page miss arbiter 632 labeled “PM ARB”, and an output register 634. Page miss arbiter 632 has a first input connected to command queue 520, a second input, and an output. Register 634 has a data input connected to the output of page miss arbiter 632, a clock input for receiving the UCLK signal, and an output. Final arbiter 650 has a first input connected to the output of refresh logic 532, a second input from a page close predictor 662, a third input connected to the output of output register 614, a fourth input connected to the output of output register 624, a fifth input connected to the output of output register 634, a first output for providing a first arbitration winner to queue 514 labeled “CMD1”, and a second output for providing a second arbitration winner to queue 514 labeled “CMD2”.

Control circuits 660 include timing block 534 and row-buffer aware page table 536 as previously described with respect to FIG. 5, and a page close predictor 662. Timing block 534 has an input and an output connected to the first inputs of page hit arbiter 612, page conflict arbiter 622, and page miss arbiter 632. Row-buffer aware page table 536 has an input connected to an output of replay queue 530, an output connected to an input of replay queue 530, an output connected to the input of command queue 520, an output connected to the input of timing block 534, and an output connected to the input of page close predictor 662. Page close predictor 662 has an input connected to one output of row-buffer aware page table 536, an input connected to the output of output register 614, and an output connected to the second input of final arbiter 650.

In operation, arbiter 538 selects memory access requests (commands) from command queue 520 and refresh logic 532 by taking into account the page status of each entry, the priority of each memory access request, and the dependencies between requests. The priority is related to the quality of service or QoS of requests received from the AXI4 bus and stored in command queue 520, but can be altered based on the type of memory access and the dynamic operation of arbiter 538. Arbiter 538 includes three sub-arbiters that operate in parallel to address the mismatch between the processing and transmission limits of existing integrated circuit technology. The winners of the respective sub-arbitrations are presented to final arbiter 650. Final arbiter 650 selects between these three sub-arbitration winners as well as a refresh operation from refresh logic 532, and may further modify a read or write command into a read or write with auto-precharge command as determined by page close predictor 662.

Each of page hit arbiter 612, page conflict arbiter 622, and page miss arbiter 632 has an input connected to the output of timing block 534 to determine timing eligibility of commands in command queue 520 that fall into these respective categories. Timing block 534 includes an array of binary counters that count durations related to the particular operations for each bank in each rank. The number of timers needed to determine the status depends on the timing parameter, the number of banks for the given memory type, and the number of ranks supported by the system on a given memory channel. The number of timing parameters that are implemented in turn depends on the type of memory implemented in the system. For example, GDDR5 memories require more timers to comply with more timing parameters than other DDRx memory types. By including an array of generic timers implemented as binary counters, timing block 534 can be scaled and reused for different memory types.

A page hit is a read or write cycle to an open page, or a read cycle (in some implementations both a read cycle and a write cycle) to a page that is stored in a row buffer. Page hit arbiter 612 arbitrates between accesses in command queue 520 that are page hits. The timing eligibility parameters tracked by timers in timing block 534 and checked by page hit arbiter 612 include, for example, row address strobe (RAS) to column address strobe (CAS) delay time (t_{RCD}) and CAS latency (t_{CL}). For example, t_{RCD} specifies the minimum amount of time that must elapse before a read or write access to a page after it has been opened in a RAS cycle. Page hit arbiter 612 selects a sub-arbitration winner based on the assigned priority of the accesses. In one implementation, the priority is a 4-bit, one-hot value that therefore indicates a priority among four values, however it should be apparent that this four-level priority scheme is just one example. If page hit arbiter 612 detects two or more requests at the same priority level, then the oldest entry wins.

A page conflict is an access to one row in a bank when another row in the bank is currently activated. Page conflict arbiter 622 arbitrates between accesses in command queue 520 to pages that conflict with the page that is currently open in the corresponding bank and rank. Page conflict arbiter 622 selects a sub-arbitration winner that causes the issuance of a precharge command. The timing eligibility parameters tracked by timers in timing block 534 and checked by page conflict arbiter 622 include, for example, active to precharge command period (t_{RAS}). Page conflict arbiter 622 selects a sub-arbitration winner based on the assigned priority of the access. If page conflict arbiter 622 detects two or more requests at the same priority level, then the oldest entry wins.

A page miss is an access to a bank that is in the precharged state. Page miss arbiter 632 arbitrates between accesses in command queue 520 to precharged memory banks. The timing eligibility parameters tracked by timers in timing block 534 and checked by page miss arbiter 632 include, for example, precharge command period (t_{RP}). If there are two or more requests that are page misses at the same priority level, then the oldest entry wins.

Each sub-arbiter outputs a priority value for their respective sub-arbitration winner. Final arbiter 650 compares the priority values of the sub-arbitration winners from each of page hit arbiter 612, page conflict arbiter 622, and page miss arbiter 632. Final arbiter 650 determines the relative priority among the sub-arbitration winners by performing a set of relative priority comparisons taking into account two sub-arbitration winners at a time.

After determining the relative priority among the three sub-arbitration winners, final arbiter 650 then determines whether the sub-arbitration winners conflict (i.e., whether they are directed to the same bank and rank). When there are no such conflicts, then final arbiter 650 selects up to two sub-arbitration winners with the highest priorities. When there are conflicts, then final arbiter 650 complies with the following rules. When the priority value of the sub-arbitration winner of page hit arbiter 612 is higher than that of page conflict arbiter 622, and they are both to the same bank and rank, then final arbiter 650 selects the access indicated by page hit arbiter 612. When the priority value of the sub-arbitration winner of page conflict arbiter 622 is higher than that of page hit arbiter 612, and they are both to the same bank and rank, final arbiter 650 selects the winner based on several additional factors. In some cases, page close predictor 662 causes the page to close at the end of the access indicated by page hit arbiter 612 by setting the auto precharge attribute.

Within page hit arbiter 612, priority is initially set by the request priority from the memory accessing agent but is adjusted dynamically based on the type of accesses (read or write) and the sequence of accesses. In general, page hit arbiter 612 assigns a higher implicit priority to reads, but implements a priority elevation mechanism to ensure that writes make progress toward completion.

Whenever page hit arbiter 612 selects a read or write command, page close predictor 662 determines whether to send the command with the auto-precharge (AP) attribute or not. During a read or write cycle, the auto-precharge attribute is set with a predefined address bit and the auto-precharge attribute causes the DDR device to close the page after the read or write cycle is complete, which avoids the need for the memory controller to later send a separate precharge command for that bank. Page close predictor 662 takes into account other requests already present in command queue 520 that access the same bank as the selected command. If page close predictor 662 converts a memory access into an AP command, the next access to that page will be a page miss.

Arbiter 538 supports issuing of either one command or two commands per memory controller clock cycle. For example, DDR4 3200 is a speed bin of DDR4 DRAM that operates with a memory clock frequency of 1600 MHZ. If the integrated circuit process technology allows memory controller 500 to operate at 1600 MHZ, then memory controller 500 can issue one memory access every memory controller clock cycle. In this case, final arbiter 650 is enabled to operate in a 1× mode to select only a single arbitration winner every memory controller clock cycle.

However, for higher speed memory, such as DDR4 3600 or LPDDR4 4667, the 1600 MHz memory controller clock speed may be too slow to use the full bandwidth of the memory bus. To accommodate these higher performance DRAMs, arbiter 538 also supports a 2× mode in which final arbiter 650 selects two commands (CMD1 and CMD2) every memory controller clock cycle. Arbiter 538 provides this mode to allow each sub-arbiter to work in parallel using the slower memory controller clock. As shown in FIG. 6, arbiter 538 includes three sub-arbiters, and in 2× mode, final arbiter 650 selects two arbitration winners as the best two of three.

Note that the 2× mode also allows memory controller 500 to operate at a slower memory controller clock speed than its highest speed to align the memory controller command generation to the memory clock cycle. For the example of DDR4 3600 when the memory controller can operate up to a clock speed of 1600 MHZ, the clock speed can be reduced to 900 MHz in 2× mode.

By using different sub-arbiters for different memory access types, each arbiter can be implemented with simpler logic than if it were required to arbitrate between all access types (page hits, page misses, and page conflicts). Thus, the arbitration logic can be simplified and the size of arbiter 538 can be kept relatively small. By using sub-arbiters for page hits, page conflicts, and page misses, arbiter 538 allows the picking of two commands which pair well with each other to hide latency accesses with data transfers.

In other implementations, arbiter 538 could include a different number of sub-arbiters as long as it has at least two to support 2× mode. For example, arbiter 538 could include four sub-arbiters and would allow up to four accesses to be picked per memory controller clock cycle. In yet other implementations, arbiter 538 could include two or more sub-arbiters of any single type. For example, arbiter 538 could include two or more page hit arbiters, two or more page conflict arbiters, and/or two or more page miss arbiters. In this case, arbiter 538 is able to select two or more accesses of the same type during each controller cycle.

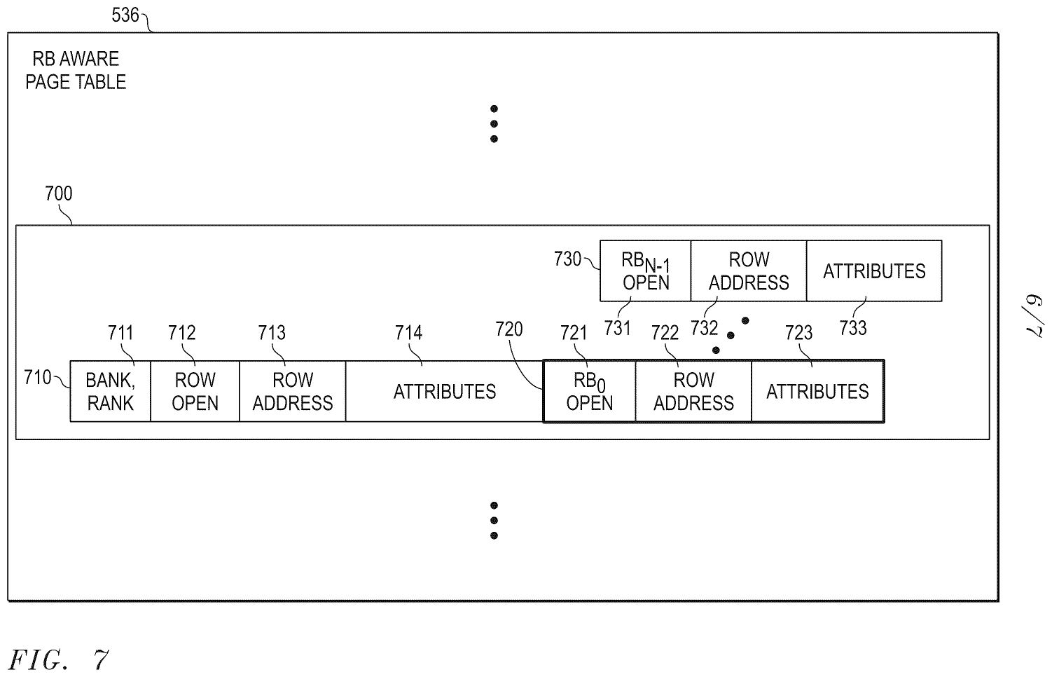

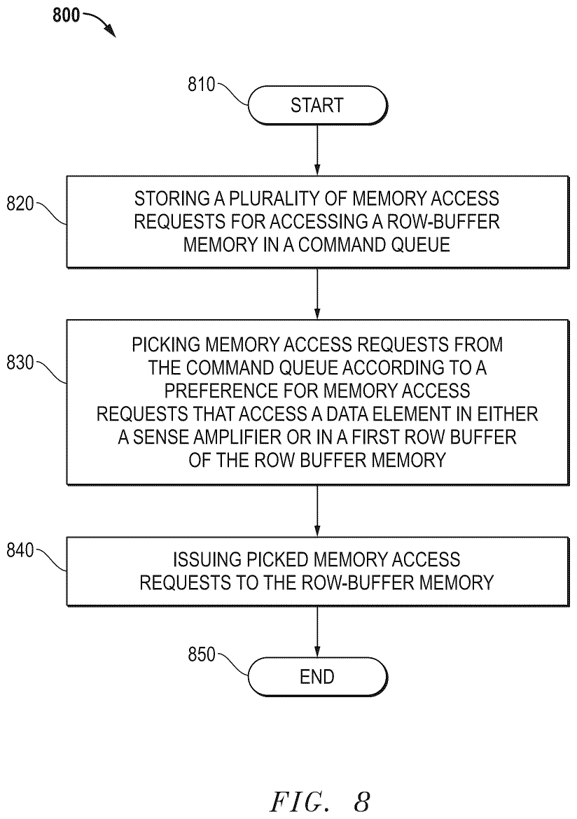

FIG. 7 illustrates a block diagram of row-buffer aware page table 536 of FIG. 5 according to some implementations. Row-buffer aware page table 536 includes a set of entries of which an entry 700 is an example. In some implementations, row-buffer aware page table 536 includes only entries for a subset of pages that have an active row or row buffer to save circuit area. In other implementations, row-buffer aware page table 536 includes a page table for each bank of each rank of memory.

Entry 700 includes a base entry 710 having a row-buffer entry 720 corresponding to it, but supports extensions for additional row buffers if present in the row-buffer memory, such as an extension entry 730 shown in FIG. 7. Base entry 710 includes a bank and rank field 711 indicating the bank and rank of the entry; a row open field 712 indicating whether the row is open; a row address field 713 storing the row address of the open page in the bank and rank; and a field 724 containing a set of attributes for the open row.

Bank and rank field 711 is a content addressable field that allows a memory access request in command queue 520 to determine whether there is a corresponding entry in row-buffer aware page table 536 so that the access can be indicated to a page hit, a page miss, or a page conflict. If the bank and rank of the memory access request matches that of a command queue entry, then row address field 713 can be used to determine whether the memory access request is a page hit, a page miss, or a page conflict. Bank and rank field 711 is used for implementations whose page table has less than one entry per rank and bank. For example, if there is no match, then arbiter 538 treats the access in command queue 520 as if it were an access to a closed page, i.e., a page miss. Implementations with enough entries can omit this field since the entries are direct-mapped and accessible by their physical location in row-buffer aware page table 536.

Row open field 712 indicates whether the row is open in memory, i.e., whether the latching sense amplifiers store the contents of the row. Arbiter 538 uses row open field 712 to determine whether an access to a given row is a page miss, to efficiently mix accesses to open and closed pages, and to schedule the accesses using the appropriate sub-arbiter.

Row address field 713 indicates the row address of an open page. Arbiter 538 uses this value to determine whether an access in command queue 520 is a page hit or a page conflict by comparing the address of the memory access request to the row address of the open row in row address field 713.

Attributes field 714 stores certain useful attributes of the access. For example, attributes field 714 can include one or more bits that allow the arbiter or associated arbitration circuitry such as a page close predictor to determine whether to auto-precharge the bank after an access. It can also contain other useful information about the access.

Row-buffer entry 720 includes a row buffer open field 721 indicating whether a first row buffer labelled “RB₀” associated with the bank and rank was recently open and stores its data; a row address field 722 containing the row address of RB₀; and an attributes field 723 containing a set of attributes of row buffer RB₀.

Extension entry 730 is an optional entry that is used in implementations in which the row-buffer memory has multiple row buffers per bank and rank. Extension entry 730 includes a row buffer field 731 indicating whether a buffer labelled “RB_{N-1}” associated with the bank and rank was recently open and stores its data; a row address field 732 containing the row address of RB_{N-1}; and an attributes field 733 containing a set of attributes of row buffer RB_{N-1}.

It should be apparent that various page table structures could be integrated, in whole or in part, with either command queue 520 or enhanced arbiter 538.

FIG. 8 illustrates a flow chart of a method 800 of accessing a row-buffer memory by a memory controller according to some implementations. Method 800 starts in an action box 810. An action box 820 includes storing a plurality of memory access requests for accessing a row-buffer memory (e.g., row-buffer memory 120 of FIG. 1) in a command queue (e.g., command queue 520 of FIG. 5). An action box 830 includes picking memory access requests from the command queue according to a preference for memory access requests that access a data element in either a sense amplifier or in a first row buffer of the row-buffer memory. An action box 840 includes issuing picked memory access requests to the row-buffer memory. Method 800 ends in an action box 850.

In the exemplary implementation, the steps of method 800 are implemented in hardware circuitry. While the operation of this circuitry has been shown with functional blocks, specific circuitry has not been shown in detail, but the construction of the described functions in hardware circuitry would be readily apparent to those of ordinary skill in the art. For example, the circuitry could include timers, counters, state machines, registers, digital logic, and the like to implement method 800.

Thus, a memory controller, data processing system, and method have been described that allow a memory controller to improve data bus utilization of a memory bus by accessing a row-buffer memory. The memory controller includes a command queue and an arbiter coupled to the command queue and operable to pick memory access requests from the command queue for issuance to the row-buffer memory according to a preference for memory access requests that access a data element in either a sense amplifier or in a first row buffer of the row-buffer memory. By marking both of these access types as page hits, a row-buffer memory can be utilized to increase bus efficiency with only a minimal increase in circuit area and without re-design of complex circuit blocks.

Memory controller 500 of FIG. 5 or any portions thereof, such as arbiter 538, row-buffer aware page table 536, or a system-on-chip using memory controller 500, may be described or represented by a computer accessible data structure in the form of a database or other data structure which can be read by a program and used, directly or indirectly, to fabricate integrated circuits. For example, this data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates that also represent the functionality of the hardware comprising integrated circuits. The netlist may then be placed and routed to produce a data set describing geometric shapes to be applied to masks. The masks may then be used in various semiconductor fabrication steps to produce the integrated circuits. Alternatively, the database on the computer accessible storage medium may be the netlist (with or without the synthesis library) or the data set, as desired, or Graphic Data System (GDS) II data.

While particular implementations have been described, various modifications to these implementations will be apparent to those skilled in the art. For example, the number of row buffers per bank, and the corresponding row buffer page table entries, can vary between implementations. The arbitration algorithms used by arbiter 538 in consideration of the availability of the row buffers can also vary. In the exemplary implementation, an older row buffer entry could be overwritten using a read or write access with an auto-precharge attribute, but in other implementations, the precharge operation could be separated from the last access in the sense amplifier. Also, the row-buffer memory architecture can be modified to accommodate write cycles to the row buffer as well as read cycles.

Accordingly, it is intended by the appended claims to cover all modifications of the disclosed implementations that fall within the scope of the disclosed implementations.

What is claimed is:

1. A memory controller, comprising:
a command queue operable to store a plurality of memory access requests for accessing a row-buffer memory; and
an arbiter coupled to the command queue and operable to pick memory access requests from the command queue for issuance to the row-buffer memory according to a preference for memory access requests that access a data element in a sense amplifier or in a first row buffer of the row-buffer memory.

2. The memory controller of claim 1, wherein the memory access requests that access the data element in the first row buffer of the row-buffer memory comprise:
read and write requests to a first memory location whose data is stored in the first row buffer of the row-buffer memory.

3. The memory controller of claim 1, wherein the memory access requests that access the data element in the first row buffer of the row-buffer memory comprise:
read requests but not write requests to a first memory location whose data is stored in the first row buffer of the row-buffer memory.

4. The memory controller of claim 1, wherein each of the plurality of memory access requests selectively accesses one of a plurality of row buffers including the first row buffer.

5. The memory controller of claim 1, further comprising:
a row-buffer aware page table operable to store information about rows stored in the sense amplifier and in the first row buffer of the row-buffer memory, wherein the row-buffer aware page table comprises a plurality of entries, wherein each entry is operable to store information about an open row for a corresponding bank of the row-buffer memory, and information about the first row buffer for the corresponding bank of the row-buffer memory.

6. The memory controller of claim 5, wherein each entry is further operable to store information about a plurality of row buffers including the first row buffer for corresponding banks of the row-buffer memory.

7. The memory controller of claim 5, wherein the information about the open row for the corresponding bank of the row-buffer memory comprises:
a bank and rank field;
a first row address field and a row open field indicating whether a row corresponding to a row address stored in the first row address field is stored in a sense amplifier of the row-buffer memory; and
a second row address field and a row buffer open field indicating whether a recently open row corresponding to a row buffer address stored in the second row address field is stored in a first row buffer of the row-buffer memory.

8. The memory controller of claim 7, wherein the row-buffer aware page table is operable to update the row open field of an entry in the command queue in response to the memory controller sending one of an activate command and a precharge command for the corresponding bank to the row-buffer memory.

9. The memory controller of claim 1, wherein the arbiter comprises:
a plurality of sub-arbiters for providing a plurality of sub-arbitration winners from among the memory access requests, comprising a page hit arbiter operable to pick page-hit access requests from the command queue according to the preference for memory access requests that access an open row or a recently open row in the row-buffer memory; and
a final arbiter for selecting between the plurality of sub-arbitration winners to provide at least one memory command for dispatch to the row-buffer memory.

10. A data processing system, comprising:
a data processor comprising a memory controller; and
a row-buffer memory coupled to the memory controller,
wherein the memory controller comprises:
a command queue operable to store a plurality of memory access requests for accessing the row-buffer memory; and
an arbiter coupled to the command queue and operable to pick memory access requests from the command queue for issuance to the row-buffer memory according to a preference for memory access requests that access a data element in a sense amplifier or in a first row buffer of the row-buffer memory.

11. The data processing system of claim 10, wherein the memory access requests that access the data element in the first row buffer of the row-buffer memory comprise:
read and write requests to a second memory location whose data is stored in a first row buffer of the row-buffer memory.

12. The data processing system of claim 10, wherein the memory access requests that access the data element in the first row buffer of the row-buffer memory comprise:
read requests but not write requests to a first memory location whose data is stored in the first row buffer of the row-buffer memory.

13. The data processing system of claim 10, further comprising:
a row-buffer aware page table operable to store information about rows stored in the sense amplifier and in the first row buffer of the row-buffer memory, wherein the row-buffer aware page table comprises a plurality of entries, wherein each entry is operable to store information about an open row for a corresponding bank of the row-buffer memory, and information about the first row buffer for the corresponding bank of the row-buffer memory.

14. The memory controller of claim 13, wherein each entry is further operable to store information about a plurality of row buffers including the first row buffer for corresponding banks of the row-buffer memory.

15. The data processing system of claim 13, wherein the information about the open row for the corresponding bank of the row-buffer memory comprises:
a bank and rank field;
a first row address field and a row open field indicating whether a row corresponding to a row address stored in the first row address field is stored in a sense amplifier of the row-buffer memory; and
a second row address field and a row buffer open field indicating whether a recently open row corresponding to a row buffer address stored in the second row address field is stored in a first row buffer of the row-buffer memory.

16. The data processing system of claim 15, wherein the row-buffer aware page table is operable to update the row open field of an entry in the command queue in response to the memory controller sending one of an activate command and a precharge command for the corresponding bank to the row-buffer memory.

17. The data processing system of claim 13, wherein the information about the rows stored in the sense amplifier and in the first row buffer of the row-buffer memory, comprises:
a second row address field; and
a row buffer open field indicating whether a row corresponding to a row buffer address is stored in the second row address field of the command queue.

18. A method of accessing a row-buffer memory by a memory controller, comprising:
storing a plurality of memory access requests for accessing the row-buffer memory in a command queue;
picking memory access requests from the command queue according to a preference for memory access requests that access a data element in either a sense amplifier or in a first row buffer of the row-buffer memory; and
issuing picked memory access requests to the row-buffer memory.

19. The method of claim 18, wherein the storing comprises:
receiving a first memory access request to a first memory bank and a first rank;
storing the first memory access request in the command queue and a row status thereof in a row-buffer aware page table; and
setting the row status of the first memory access request accesses to open if a row of the first memory access request is currently open in the row-buffer memory.

20. The method of claim 19, wherein the picking comprises:
picking memory access requests from the command queue according to a preference for memory access requests that access a data element in either a sense amplifier or in one of a plurality of row buffers including the first row buffer of the row-buffer memory.
